(19) United States
(12) Patent Application Publication
(10) Pub. No.: US 2007/0177551 A1
(43) Pub. Date: Aug. 2, 2007

(54) Method for transmitting signals in a radiocommunication system and corresponding transmitter station and receiver station

(76) Inventors: Michael Joham, Munchen (DE); Josef Nossek, Iffeldorf (DE); Alexander Seeger, Feldkirchen (DE); Wolfgang Utschick, Ingolstadt (DE); Benno Zerlin, Munchen (DE)

Correspondence Address: STAAS & HALSEY LLP, SUITE 700, 1201 NEW YORK AVENUE, N.W., WASHINGTON, DC, 20005, US

(21) Appl. No.: 10/570,309

(22) PCT Filed: Aug. 12, 2004
(86) PCT No.: PCT/EP04/51780

§ 371 Date: Oct. 26, 2006

(30) Foreign Application Priority Data
Sep. 2, 2003 (DE) 10340397.3

(51) Int. Cl. H04Q 7/00; H04B 7/216

(52) U.S. Cl. 370/332; 370/335

(57) ABSTRACT

A method transmits signals of a link between a transmitting station and a receiving station of a radiocommunication system, wherein at least one pilot signal is transmitted between the stations NB and UE in order to enable estimation of at least one channel of said link by the receiving station. The channel estimation results are determined in order to detect data to be transmitted to the receiving station by means of the signals of the link. Deviation between the transmission characteristics of the pilot signal used for channel estimation and the transmission characteristics of the signals of the link is taken into account when the signals of the link which are to be transmitted are produces by the transmitting station and/or when the received signals of the link are processed by the receiving station.

### CROSS REFERENCE TO RELATED APPLICATIONS

This application is based on and hereby claims priority to PCT Application No. PCT/EP2004/051780 filed on Aug. 12, 2004 and German Application No. 10340397.3 filed Sep. 2, 2003, the contents of which are hereby incorporated by reference.

### BACKGROUND OF THE INVENTION

The invention relates to a method for transmitting signals of a link between a transmitting station and a receiving station of a radiocommunication system and a corresponding transmitter station and a receiver station.

In radiocommunication systems communication takes place between the stations sharing in a link via electromagnetic waves across an air interface. Mobile radio systems are a special form of radiocommunication systems, whereby a base station on the network side covers a service area, in which a large number of subscriber stations, usually mobile ones, can be present. In the case of cellular mobile radio systems, a large number of base stations have service areas called “radio cells”, which allow them to service larger geographical areas. Examples of cellular mobile communication systems are the IS-95 which is widespread in the USA in particular, and GSM (Global System of Mobile Communication) which is especially dominant in Europe. The so-called third generation cellular mobile communication systems, for example, CDMA2000 and UMTS (Universal Mobile Telecommunication System), are currently being developed.

To realize simple receiver structures, such as, for example, rake receivers, in the subscriber stations, the signals which are to be transmitted by the base station can be predistorted accordingly, so that coherent detection of the signal components of different possible propagation paths of the signals is possible in the receiving subscriber stations. With a rake receiver, for example, a rake finger is assigned to each path. Each rake finger collects the signal components of one of the propagation paths, corrects the phase displacement and weight the signal component in terms of maximum ratio combining. In order to be able to carry out the phase correction and the real-valued weighting in the proper manner, the subscriber station must estimate the complete vector channel, i.e. the complex amplitude [ρ] and the standardized channel vector a for all propagation paths.

A channel estimation in the downlink (direction from the base station to the subscriber station) based on the so-called S-CPICH (Secondary Common Pilot Channel) has been proposed for UMTS, whereby a pilot sequence required for the channel estimation is transmitted from the base station simultaneously in several directions by directional beams. Thereby, for transmitting the same pilot sequence, an individual spread code is used for each direction. Thus, for each path, a subscriber station can carry out a channel estimation of the pilot signal radio beam that is best for said subscriber station, which channel estimation is used later to detect data that is to be transmitted from the base station to the subscriber station.

Whereas, when an omnidirectional pilot channel is used, only one pilot sequence is transmitted from the base station in all directions and can be used by subscriber stations for the channel estimation at any place whatsoever within the service area of the base station, with the so called grid of beams approach, which is used, for example, in the above mentioned S-CPICH, a large number of directional beams are necessary via which beams the pilot sequence must be transmitted. However, because of the beam forming gains, the pilot sequence can be transmitted at a reduced power level compared to the omnidirectional transmission via the so-called primary CPICH. In the case of the latter, different pilot signals are sent omnidirectionally simultaneously, each from one antenna. Using the S-CPICH allows the power to be reduced because of the beam forming gains.

If adaptive antennae are provided in the base station, it is also possible, as opposed to the grid of beams approach, to transmit the pilot sequence using a beam directed at the respective receiving subscriber station. This, however, requires that an individual pilot sequence be transmitted for each subscriber station. Using a shared pilot channel for several subscriber stations is no longer an option.

### SUMMARY OF THE INVENTION

One possible object of the invention is to establish a method for transmitting signals in a radiocommunication system, which method enables advantageous channel estimation and detection of data.

The inventors propose a method for transmitting signals of a link between a transmitting station and a receiving station of a radiocommunication system, at least one pilot signal is transmitted between the stations in order to enable an estimation of at least one channel of said link by the receiving station, whereby the channel estimation results are determined in order to detect data to be transmitted to the receiving station by the signals of the link. Deviation between the transmission characteristics of the pilot signal used for the channel estimation and the transmission characteristics of the signals of the link is taken into account when the signals of the link which are to be transmitted are produced by the transmitting station and/or when the received signals of the link are processed by the receiving station.

Under transmission characteristics is to be understood the form (for example, only one main lobe or several minor lobes) and the direction of the signals transmitted. A channel estimation is faulty if the propagation direction of the pilot signal used for the estimation deviates from that of the signals of the link for which the channel estimation was carried out. Errors can, however, also arise, regardless of the propagation direction of the pilot signal and of the signals of the link, from the fact that the form of the transmission characteristics for the pilot signal on the one hand, and the signals of the link on the other hand, deviate from each other. In the following, the first mentioned case is frequently the only one taken into account, even when the embodiments also apply to the latter case.

The invention thus relates to the case where the transmission characteristics in respect of propagation directions and/or form for the pilot signal and the signals of the link diverge, as can be the case, for example, when adaptive antennae are used to transmit the signals of the link and when the pilot signals are transmitted by a directional beam in a fixed direction.

The invention is thus especially applicable when the above-mentioned grid of beams approach is used. With the grid of beams, it often happens that a subscriber station is not sited directly in the main propagation path of the pilot beam and as a consequence a channel estimation carried out using this pilot beam does not fully apply for the signals of the link, in as far as the latter is done using directional beams individually adapted to the position of the subscriber station. Taking into account the deviation between the transmission characteristics or propagation directions of the pilot signals on the one hand and of the signals of the link on the other hand, advantageously enables an at least partial compensation of the error in estimation of the channel for the signals of the links made using the pilot signal, said error resulting from the deviation of the propagation directions.

According to a first embodiment of the invention, the deviation of the transmission characteristics is taken into account at the receiver side when the received signals of the link are processed by the receiving station. To this end it is necessary for the receiving station to have information regarding the deviation of the transmission characteristics. This is, for example, the case when, by using appropriate methods for locating, such as, for example, GPS (Global Positioning System), the subscriber station knows its own position relative to the transmitting station and the transmission characteristics of the pilot signal relative to the base station. The transmission characteristics of the pilot signal may be known to the receiving station for the reason, for example, that the transmitting station informs it of these via a corresponding control channel. If the transmitting station is, for example, a base station in a mobile communication system, and the receiving station a corresponding subscriber station, such a control channel of the base station can be received by all subscriber stations within the service area of the base station.

According to a second embodiment of the invention, the deviation of the transmission characteristics is taken into account at the transmitter side when the signals of the link which are to be transmitted are produced by the transmitting station. Establishing the deviation can be carried out easily, as the transmitting station by definition knows the transmission characteristics both of the pilot signal and of the signals of the link.

The invention can be applied to any radiocommunication system wherein a channel estimation is performed prior to a detection of data and wherein a deviation between the transmission characteristics of the pilot signals used for the channel estimation and the transmission characteristics of the signals of the corresponding link can occur. The latter is equal to a deviation of the propagation paths of the pilot signal from the propagation paths of the signal of the link. Thus the invention is in particular also applicable when, for example, the relative arrangement of the transmitting and receiving station changes subsequent to the channel estimation being performed using the pilot signal and hence the channel for the signals of the link also changes although the results of the preceding channel estimation are to continue to be used. The invention is particularly well suited for use in radiocommunication systems with mobile transmitting or receiving stations.

According to a development of the second embodiment of the invention, in a first step, a measure is estimated for the deviation of the signal characteristics. In a second step, the signals of the link are predistorted according to the estimated measure before they are transmitted by the transmitting station.

According to a development of this object, in order to carry out the first step the results of an estimation of the at least one channel of the link are made available in the transmitting station and the results of this channel estimation is combined with information about the transmission characteristics of the pilot signal in order to determine the measure of the deviation.

The channel estimation results made available in the transmitting station can either be based on the channel estimation carried out by the receiving station using the pilot signal and the receiving station can convey said channel estimation results to the transmitting station. This has the advantage that the results of the same channel estimation carried out in the receiving station can be used both in the receiving station in order to detect data and in the transmitting station in order to predistort the signals that are to be transmitted, with which signals the data will be transmitted.

Alternatively, it is also possible that the channel estimation results made available in the transmitting station are determined by the transmitting station itself, in which said transmitting station carries out its own channel estimation for the channel between the transmitting station and the receiving station. This can, for example, be achieved by deriving the channel estimation results from results of an estimation of the channel for the opposite transmission direction (i.e. from the receiving station to the transmitting station). In particular if the same frequency is used for both transmission directions, as in a TDD procedure (Time Division Duplex), one can assume reciprocity of the channels in both transmission directions, so that the channel estimation results for both transmission directions match to the greatest possible extent.

According to a development of the invention, the results of the channel estimation made available in the transmitting station respectively relate to a covariance matrix for each of the channels of the link. An eigenvalue analysis is made for each covariance matrix, whereby eigenvectors are determined with the dominant eigenvalues. The measure of deviation is determined by combining a result of the eigenvalue analysis with the information about the transmission characteristics of the pilot signal.

It is favorable if the receiving station uses a rake receiver to detect the data. By taking into account, in accordance with the invention, the deviation between the transmission characteristics of the pilot signal and of the signals of the link, it is advantageously possible, despite the deviation, to achieve coherent detection at the output of the rake receiver.

According to a development of the invention, the transmitting station transmits a majority of pilot signals in respectively determined directions, and the receiving station uses at least one of these pilot signals for the channel estimation. The invention is thus particularly suitable for use in the above-mentioned grid of beams approach.

### BRIEF DESCRIPTION OF THE DRAWINGS

These and other objects and advantages of the present invention will become more apparent and more readily appreciated from the following description of the preferred embodiments, taken in conjunction with the accompanying drawings of which: by

FIG. 1 shows the transmission of a plurality of pilot signals by a transmitting station using the so-called grid of beams approach,

FIG. 2 shows the deviation of the propagation directions of a pilot signal used for the channel estimation and signals of a link,

FIG. 3 shows components of the transmitting station from FIGS. 1 and 2 and

FIG. 4 shows components of a receiving station from FIG. 2.

### DETAILED DESCRIPTION OF THE PREFERRED EMBODIMENT

Reference will now be made in detail to the preferred embodiments of the present invention, examples of which are illustrated in the accompanying drawings, wherein like reference numerals refer to like elements throughout.

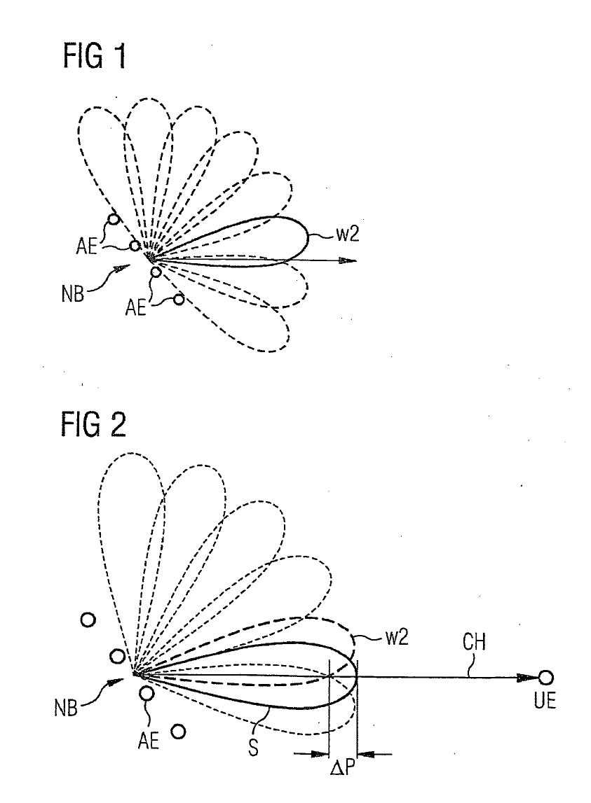

FIG. 1 shows a transmitting station NB in the form of a base station of a mobile communication system, which base station has an adaptive antenna with, by way of example, four antenna elements AE. By the adaptive antenna, the transmitting station NB uses directional beams to transmit at intervals and in different directions a large number of different pilot signals with the same form of their transmission characteristics, as per the grid of beams approach. In FIG. 1, only one of the pilot signals w2 is illustrated with an unbroken line, while the remaining pilot signals are illustrated with broken lines.

FIG. 2 shows, further to FIG. 1, a receiving station UE in the form of a subscriber station in the mobile communication system. Moreover, the transmission characteristics of the pilot signal w2 from FIG. 1 are represented with a broken line. The unbroken line was used in FIG. 2 to represent the directional characteristics of signals S, which the transmitting station NB transmits to the receiving station UE according to a link between said transmitting station and said receiving station. FIG. 2 shows the dependence of the received power on the angle of the transmission.

FIG. 2 shows that the propagation direction of the pilot signals w2 deviates from the propagation direction of the signals S of the link. The receiving station UE uses the pilot signal w2 to perform a channel estimation for channel CH of the link between the transmitting station NB and the receiving station UE. Because of the deviation between the propagation direction of the pilot signal w2 and the propagation direction of the signals S of the link, this channel estimation is, however, flawed (in this embodiment it is assumed that pilot signal w2 and signals S of the link have transmission characteristics that do not differ in form but only in direction. It can, however, be the other way round or the characteristics can differ both in respect of form and of direction).

In this embodiment it is assumed that there is only a spatial path between transmitting station NB and receiving station UE. The phase error caused by this inaccurate channel estimation is 45°. The reason for this is that the propagation directions of the pilot signal w2 and the signals S differ from each other by 11°.

This phase difference would be avoided if the signals S were to be transmitted with the same transmission characteristics or propagation direction as the pilot signal w2. Then, however, the received power at the receiving station UE would be less than if the signals S were to be transmitted in the direction of the receiving station UE. The corresponding difference ΔP of the received power at the receiving station UE for the case mentioned is illustrated clearly in FIG. 2. The signals S are transmitted directly in the direction of the receiving station UE, thus avoiding this loss of received power. The phase error that occurs because of this is compensated for by predistorting the signals S.

In a first embodiment, the receiving station UE independently determines the difference between the propagation directions of the pilot signal w2 and of the signals S of the link and carries out a corresponding, at least partial, correction of the channel estimation made using the pilot signals w2. In this way, subsequently the data transmitted by the signals of the link are detected with a more accurate (as corrected) channel estimation. In this embodiment, the transmitting station NB conveys information on the deviation of the propagation direction of the pilot signal w2 from that of the signals S to the receiving station UE.

In a second exemplary embodiment, the transmitting station NB takes into account the deviation between the propagation directions of the pilot signal w2 and of the signals S of the link when said station produces the signals of the link which are to be transmitted, and it does so in a first step by estimating the error in the channel estimation for the link, which estimation is to be carried out by the receiving station UE. Subsequently, in a second step, the signals S of the link are predistorted according to the estimated error before they are transmitted by the transmitting station NB.

FIG. 3 shows some essential components of the transmitting station NB from FIGS. 1 and 2. It shows an adaptive first antenna device A1, which is formed using the antenna elements AE illustrated in FIG. 1 and FIG. 2. It serves to transmit the pilot signal w2 and the signals S of the link. The pilot signal w2 and the rest of the pilot signals illustrated in FIG. 1 are produced by a unit P and transmitted via a transmitter unit TX to the first antenna device A1. Via the first antenna device A1 the transmitting station NB also receives results RCH of the channel estimation performed by the receiving station UE using the pilot signal w2. The results RCH are fed from the first antenna device A1 via a receiver unit RX to a signal processing unit SP. Within the signal processing unit SP the signals S of the link are generated, and the predistorting described also takes place to compensate for the inaccurate channel estimation. Thereby the signal processing unit SP uses the results RCH of the channel estimation performed by the receiving station UE.

With other exemplary embodiments, it is also possible that the transmitting station NB does not receive any results RCH of the channel estimation performed by the receiving station UE, but independently carries out an estimation of the channel of the link for the transmission direction from the transmitting station NB to the receiving station UE. Such a channel estimation can be derived, for example from the estimation of the channel for the opposite transmission direction, i.e. from the receiving station UE to the transmitting station NB.

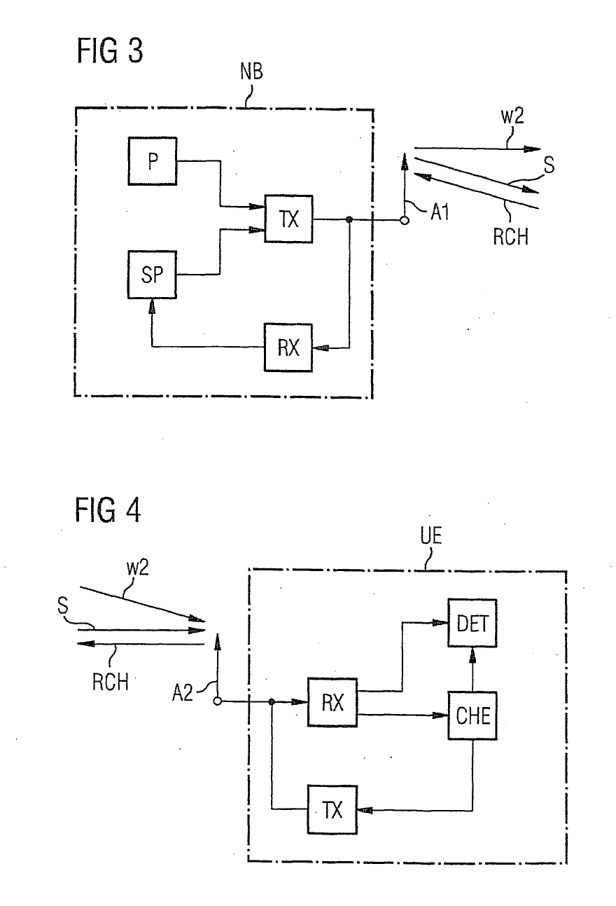

FIG. 4 shows some essential components of the receiving station UE from FIG. 2. Said receiving station receives the pilot signal w2 and the signals S of the link via a second antenna device A2. Both are forwarded via a receiver unit RX to subsequent components. The pilot signal w2 is forwarded to a channel estimation unit CHE, which uses the pilot signal to carry out an estimation of the channel of the link in the direction from the transmitting station NB to the receiving station UE. The receiver unit RX feeds the signals S of the link to a data detector DET which has an integrated rake receiver whose fingers were set according to the channel estimation performed by the channel estimation unit CHE. The result of the channel estimation is also transmitted from the receiving station UE to the transmitting station NB by the channel estimation unit CHE via a transmitter unit TX and the second antenna device A2 in the form of the results RCH of the channel estimation.

That, the error in the channel estimation are compensated for by the receiving station UE has the advantage that coherent detection by the data detector DET becomes possible despite the use of the grid of beam approach. The error in the determination of the phase distortion through the channel CH can at least be reduced if not even totally avoided.

In the second exemplary embodiment, the systematic estimation error of the receiving station UE is predicted by the transmitting station NB and can, therefore, be incorporated into the calculation of a transmit filter which is used for the predistortion of the signals S in the transmitting station NB. Thus the transmitting station NB can reduce or even totally remove the error of the channel estimation by the receiving station UE. In the following, it is assumed that the pilot signals used here are the so-called S-CPICH (Secondary Common Pilot Channel) of the UMTS Standard. Below, an algorithm for carrying out the method is explained in more detail.

In the following, the equations below apply for the signals S of the link and the pilot signal w2:
S=p₁*s[n]and
w2=w_{S-CPICH}*PN
whereby p₁ and w_{S-CPICH} are weighting factors for the antenna elements AE of the transmitting station NB, s[n] is the sequence of the data which is to be transmitted with the signal S and PN is the sequence of the pilot symbols which are to be transmitted with the pilot signal w2.

The S-CPICH pilot sequence is transmitted via the grid of beams and is hence weighted with a fixed vector w_{S-CPICH}^{T}. The channel CH is assumed with Q time resolvable paths, of which each is described through the M eigenvectors a_{q,1}, . . . , a_{q,M}, the associated complex attenuations P_{q,1}, . . . , P_{q,M} and the delay V_{q}. Therefore, the rake receiver of the receiving station UE is tuned to the pilot channel:

$${h}_{S \text{-} CPICH} [ n ] = {\sum }_{q = 0}^{Q} {\sum }_{m = 1}^{M} {ρ}_{q , m} \underbrace{{w}_{S \text{-} CPICH}^{T}}_{{a}_{q , ru}^{*}} {a}_{q , m} δ [ n - {v}_{q} ] ,$$

and adapts its coefficients

$${\sum }_{r = 1}^{M} {p}_{f , r}^{*} {α}_{f , r} ,$$

with f=0, . . . , Q. Therein, the complex factor a_{f,r}=w_{S-CPICH}^{T}a_{f,r} describes the corruption of weights within the finger of the rake receiver (hereinafter referred to as “rake weights”), arranged in the data detector DET, within the receiving station UE by the S-CPICH channel estimation.
1) In a first step, the transmitting station NB calculates the occurring corruption of the rake weights at the receiving station UE, that occurs from using the S-CPICH for the channel estimation.
   a. in order to determine the relevant spatial eigenvectors a_{f,r}, the transmitting station NB estimates the downlink covariance matrices of all Q paths. The spatial components a_{f,r} are determined by an eigenvalue analysis of each of these covariance matrices.
   b. The S-CPICH diagram shaping vector w_{S-CPICH}^{T} used is always known to the transmitting station NB.
   c. The combination of these two quantities enables the missetting of the rake receiver due to the inaccurate estimation of channel CH to be calculated in advance as
      a_{f,r}=w_{S-CPICH}^{H}a_{f,r}^{*},
      for f=0, . . . , Q and r=1, . . . , M
2) In step two, these factors α_{f,r} are used to determine the vectors p₁ of the predistorting filter within the signal processing unit SP of the transmitting station NB. The corresponding functions
ρ_{f}=f_{TxFilter}(α_{1,1,}ρ_{1,2,}a_{1,1}, . . . ,α_{Q,M,}ρ_{Q,M,}a_{Q,M}
depend on the signal processing approach (e.g. Wiener transmit filtering) used and can be derived from an adapted signal model for any approach. This signal model takes the S-CPICH channel estimation into account and hence the corruption of the signal ŝ[n] at the output of the rake receiver by the factor α_{f,r}:

$$\hat{s} [ n ] = {\sum }_{f = 0}^{Q} {\sum }_{r = 1}^{M} {ρ}_{f , r}^{*} {α}_{f , r} {\sum }_{q = 0}^{Q} {\sum }_{m = 1}^{M} {ρ}_{q , m} {a}_{q , m}^{T} {\sum }_{l = 0}^{L} {P}_{l} s [ n - l - {v}_{q} + {v}_{f} ] + … + {\sum }_{f = 0}^{Q} {K}_{r = 1}^{M} {α}_{f , r} {ρ}_{f , r}^{*} η [ n + {v}_{f} ] .$$

The principal idea, to estimate the corruption of the rake weighting coefficients of the rake receiver within the data detector DET through the inaccurate channel estimation and to incorporate this in the derivation of the transmit model used is independent of the specific scenario and of the transmit strategy used. Thus any criteria can as well be introduced for the derivation of the above-mentioned function, as can the use of two or more pilot signals (i.e. S-CPICH beams, that are calculated in different directions in accordance with FIG. 1) per channel estimation.

### EXAMPLES

1) Channels with a Time Path of Class 2

In scenarios with two discrete different propagation paths which arrive at the receiving station UE with the same time delay, the channel covariance matrix is class 2. This is also the case when the angle spread of the propagation path results in the covariance matrix having two eigenvalues different from zero.

If one assumes a scenario with only one time resolvable path (Q=1) of the class M=2 and defines the average path power σₚ_{_{q,m}}²=E[|ρ_{q,m}|²], the resulting functions f_{TxFilter} for linear transmit filters are revealed as:

$$\text{?}$$

$$\text{?} \text{indicates text missing or illegible when filed}$$

with

$$ξ = \frac{{\vert {α}_{1 , 1} \vert}^{2} {σ}_{p 1 , 1}^{2} + {\vert {α}_{1 , 2} \vert}^{2} {σ}_{{P}_{1 , 2}}^{2}}{{E}_{tr}} {σ}_{n}^{2}$$

and a standardization of P_{WF} to

$${‖ {P}_{WF} ‖}_{2}^{2} = \frac{{E}_{tr}}{{σ}_{s}^{2}} by {β}_{WF} .$$

2) Multi-User CDMA Scenarios

In a K user S-CPICH CDMA system with Q+1 channel paths of class 1, the corruption of the rake weights can be included in the signal model and hence in the solutions for linear transmit filters. When transmit filters, channels and rake receivers of the order L, Q or F are used, the signal components of the user k, which were received via the q^{th} channel path and the f^{th} rake finger, can be represented with

$${\hat{u}}_{k , q , f} [ xm ] = {\sum }_{i = 1}^{K} {p}_{i}^{T} {X}_{k , q , f} {s}_{i}^{[ m ]} + {\hat{η}}_{k , f} [ xm + f ]$$

Thereby the vector pᵢ contains all L+1 weighting vectors for the user i, in accordance with:
P _{\hat{ε}}=[P_{i,o}^{T}, . . . , P_{i,L}^{T}]^{T}
and the matrix X_{k,q,f} is defined as:

$${X}_{k , q , f} = \{ \begin{matrix}\sqrt{2} {σ}_{k , q}^{2} {α}_{k , q} {A}_{k , q , q} {C}_{k} SV & f = q , \\ {σ}_{k , f} {σ}_{k , q} {A}_{k , q , f} {C}_{k} SV & f \neq q ,\end{matrix} ∈ {ℂ}^{{N}_{a} ( L + 1 ) \times M} \\ {A}_{k , q , f} = [ {0}_{{N}_{a} ( L + 1 ) \times F + q - f} , {1}_{L + 1} ⊗ {a}_{k , q} , {0}_{{N}_{a} ( L + 1 ) \times Q + f - q} ] ∈ {ℂ}^{{N}_{a} ( L + 1 ) \times L + Q + F + 1} , \\ {C}_{k} = [ \begin{matrix}{c}_{k}^{*} [ χ - 1 ] & ⋯ & {c}_{k}^{*} [ 0 ] & 0 & ⋯ & 0 \\ 0 & {c}_{k}^{*} [ χ - 1 ] & ⋯ & {c}_{k}^{*} [ 0 ] & ⋯ & 0 \\ ⋮ & & ⋰ & & ⋰ & ⋮ \\ 0 & ⋯ & 0 & {c}_{k}^{*} [ χ - 1 ] & ⋯ & {c}_{k}^{*} [ 0 ]\end{matrix} ] ∈ {ℂ}^{L + Q + F + 1 \times L + Q + F + χ} , \\ S = [ {0}_{L + Q + F + χ \times γ χ - F ,} {1}_{L + Q + F + χ} , {0}_{L + Q + F + χ \times ( M - γ ) χ - L - Q} ] ∈ {\{ 0 , 1 \}}^{L + Q + F + χ \times M χ + χ - 1} , \\ V = [ \begin{matrix}{1}_{M} ⊗ {e}_{χ} \\ {0}_{χ - 1 \times M}\end{matrix} ] ∈ {\{ 0 , 1 \}}^{M χ + χ - 1 \times M} ,$$

with path power σ_{k,q}²=[|p_{k,q}|²] and vector eₓ which marks the last column of the x dimensional unit matrix. In addition, the vector e_{μ}, which identifies the column

$$\frac{M + 1}{2}$$

of the M dimensional unit matrix, selects the relevant chip from the impulse response of the complete system including a pre-filter, channel, rake receiver and code correlator.
2.1 Solution for Using a Signal Matched Filter (Matched Filter)

The signal matched filter follows the maximizing of the desired signal components and leads to:

$${P}_{MF , k} = {β}_{MF} {\sum }_{f = 0}^{F} \sqrt{2} {σ}_{k , f} {X}_{k , f , f}^{*} {e}_{u ,}$$

$${β}_{MF} = \sqrt{\frac{{E}_{tr}}{{\sum }_{l = 1}^{K} {σ}_{s}^{2} {e}_{μ}^{T} {\sum }_{i = 0}^{F} \sqrt{2} {σ}_{k , i} {X}_{k , i , i}^{T} {\sum }_{j = 0}^{F} \sqrt{2} {σ}_{k , j} {X}_{k , j , j}^{*} {e}_{μ}}}$$

2.2 Solution for Using an Unbiased Transmit Filter (Zero Forcing Filter)

According to the principle of zero forcing, the unbiased transmit filter is obtained by stacking

$${b}_{i , q , f} = \{ \begin{matrix}\sqrt{2} {σ}_{i , q}^{2} & for i = k and q = f \\ 0 & else\end{matrix}$$

and X_{k,q,f} for {k,q,f}={1,0,0}, . . . , {1,Q,0}, . . . ,{1,Q,F}, . . . , {K,Q,F} to b and X to:

$${P}_{ZF , k} = \sqrt{\frac{{E}_{tr}}{{\sum }_{k = 1}^{K} {σ}_{s}^{2} {b}_{k}^{T} {X}^{t , th} {X}^{t , T} {b}_{k}} {X}^{t , T} {b}_{k}}$$

2.3 Solution for Using a Wiener Transmit Filter

In the given scenario, the Wiener transmit filter results in:

$${P}_{WF , k} = \sqrt{\frac{{E}_{tr}}{{\sum }_{k = 1}^{K} {σ}_{s}^{2} {b}_{k}^{T} {{X}^{T} ( {X}^{*} {X}^{T} + γ \frac{{σ}_{yl}^{2}}{{E}_{tr}} 1 )}^{- 2.} {X}^{*} {b}_{k}} {( {X}^{*} {X}^{T} + γ \frac{σ \frac{2}{n}}{{E}_{tr}} 1 )}^{- 1} {X}^{*} {b}_{k}}$$

Explanation of Some of the Above Used Symbols:
δ[n] Dirac delta impulse at time n
s[n] Signal s at chip time n
s^{[m]} Signal s at symbol time m
   |x| Amount of complex quantity x
( )* Conjugate complex matrix
( )^{T} Transpose matrix
( )^{H} Hermit matrix, i.e. complex conjugate transpose matrix
∥x∥₂ Norm of the vectors x
1_{d} dimensional unit matrix
\textcircled{x} Kronecker product
( )^{τ} Moore-Penrose pseudo inverse of a matrix

The invention has been described in detail with particular reference to preferred embodiments thereof and examples, but it will be understood that variations and modifications can be effected within the spirit and scope of the invention covered by the claims which may include the phrase “at least one of A, B and C” as an alternative expression that means one or more of A, B and C may be used, contrary to the holding in Superguide v. DIRECTV, 69 USPQ2d 1865 (Fed. Cir. 2004).

1-11. (canceled)

12. A method for transmitting data signals, comprising:
transmitting a pilot signal;
transmitting data signals to a mobile station via a link;
determining the transmission characteristics a pilot signal;
estimating the transmission characteristics of the link based on the transmission characteristics of the pilot signal;
determining a transmission difference between the pilot signal and data signals; and
compensating for the transmission difference either in transmission of the data signals or in estimating the transmission characteristics.

13. The method for transmitting data signals according to claim 12, wherein
a plurality of pilot signals are transmitted in a plurality of predetermined different respective directions,
the data signals are transmitted directly toward a mobile station via the link,
the transmission characteristics are determined for a proximate pilot signal,
the transmission characteristics of the link are estimated based on the transmission characteristics of the proximate pilot signal, and
a directional difference between the proximate pilot signal and the link is determined as the transmission difference.

14. The method for transmitting data signals via a link between a transmitting station and a receiving station of a radiocommunication system, comprising:
transmitting at least one pilot signal between the stations to enable the receiving station to estimate transmission characteristics of said link so that the receiving station can accurately detect the data signals;
identifying a transmission difference between the pilot signal and the data signals; and
using the transmission difference to modify transmission of the data signals by the transmitting station and/or to modify processing of the data signals by the receiving station.

15. The method according to claim 17, wherein
the transmission difference is a deviation between the propagation direction of the pilot signal and the propagation direction of the data signals, and
the data signals are predistorted according to the transmission difference prior to being transmitted by the transmitting station.

16. The method according to claim 18, wherein
the reception characteristics of the pilot signal are determined,
in order to determine the deviation between the propagation directions, the reception characteristics of the pilot signal are made available to the transmitting station, and
in order to determine the deviation between the propagation directions, the reception characteristics of the pilot signal are combined with information on the transmission characteristics of the pilot signal.

17. A method for transmitting signals of a link between a transmitting station and a receiving station of a radiocommunication system, wherein
at least one pilot signal is transmitted between the stations in order to enable estimation of at least one channel (CH) of said link by the receiving station,
channel estimation results are determined in order to detect data to be transmitted to the receiving station by means of the signals of the link,
deviation between the transmission characteristics of the pilot signal used for channel estimation and the transmission characteristics of the signals of the link is taken into account when the signals of the link which are to be transmitted are produced by the transmitting station and/or when the received signals of the link are processed by the receiving station.

18. The method according to claim 17, wherein in order to take into account the deviation between the propagation directions
in a first step, a measure is estimated for the deviation of the signal characteristics,
and in a second step, the signals of the link are predistorted according to the measure prior to being transmitted by the transmitting station.

19. Method according to claim 18, wherein in order to carry out the first step
results of an estimation of the at least one channel of the link are made available in the transmitting station
and in order to determine the measure of the deviation, the results of this channel estimation is combined with information on the transmission characteristics of the pilot signals.

20. The method according to claim 19, wherein
the channel estimation results made available in the transmitting station each relate to a covariance matrix for each of the channels of the link,
an eigenvalue analysis is made for each covariance matrix by determining eigenvectors with the dominant eigenvalues,
and the measure of the deviation is determined by combining a result of the eigenvalue analysis with information on the transmission characteristics of the pilot signal.

21. The method according to claim 19, wherein
the channel estimation results made available in the transmitting station by the transmitting station are received by the receiving station.

22. The method according to claim 19, wherein
the channel estimation results made available in the transmitting station are produced through a channel estimation of the transmitting station.

23. The method according to claim 22, wherein
the channel estimation results made available in the transmitting station (NB) by the transmitting station are derived from a channel estimation carried out by the transmitting station for the transmission direction from the receiving station to the transmitting station.

24. The method according to claim 17, wherein
the receiving station uses a rake receiver for data detection.

25. The method according to claim 17, wherein the transmitting station (transmits a plurality of pilot signals respectively in set directions and the receiving station uses at least one of these pilot signals for the channel estimation.

26. A station for sending signals of a link to a receiving station of a radiocommunication system,
with means for transmitting at least one pilot signal to the receiving station (UE) to enable estimation of at least one channel of the link by the receiving station, whereby the channel estimation results are determined in order to detect data to be transmitted to the receiving station by means of the signals of the link,
with means for producing the signals of the link which are to be transmitted taking into account a deviation between the transmission characteristics of the pilot signals used for the channel estimation and the transmission characteristics of the signals of the link.

27. A station for receiving signals of a link from a transmitting station of a radiocommunication system,
with means for receiving at least one pilot signal from the transmitting station for an estimation of at least one channel of the link by the receiving station, whereby channel estimation results are determined in order to detect data to be transmitted to the receiving station by means of the signals of the link,
with means for processing the signals of the link received, taking into account a deviation between the transmission characteristics of the pilot signals used for the channel estimation and the transmission characteristics of the signals of the link.
